(19) United States
(12) Patent Application Publication
(10) Pub. No.: US 2009/0305596 A1
(43) Pub. Date: Dec. 10, 2009

(54) METHOD FOR PRODUCING PLASMA DISPLAY PANEL

(76) Inventors: Michiru KUROMIYA, Osaka (JP); Nobuyuki Shigetoh, Kyoto (JP); Satoshi Maeshima, Hyogo (JP)

Correspondence Address: WENDEROTH, LIND & PONACK L.L.P., 1030 15th Street, N.W., Suite 400 East, Washington, DC, 20005-1503, US

(21) Appl. No.: 12/477,246

(22) Filed: Jun. 3, 2009

(30) Foreign Application Priority Data
Jun. 4, 2008 (JP) 2008-146586

(51) Int. Cl. H01J 9/00

(52) U.S. Cl. 445/24

(57) ABSTRACT

A method for producing a front panel of a plasma display panel wherein an electrode, a dielectric layer and a protective layer are formed on a substrate of the front panel, a formation of the protective layer comprising the steps of: (i) forming a first protective layer by sputtering or vapor deposition process on a dielectric layer of a substrate; (ii) applying a MgO material onto the first protective layer to form a MgO material layer; and (iii) drying the Mgo material layer so as to form a second protective layer therefrom, wherein the MgO material comprises a MgO powder, a solvent A and a solvent B; a vapor pressure of the solvent A is higher than and equal to 50 Pa at 20° C.; a vapor pressure of the solvent B is lower than and equal to 7 Pa at 20° C.; and a proportion of the solvent B to all solvents contained in the MgO material is higher than and equal to 3% by weight.

### FIELD OF THE INVENTION

The present invention relates to a method for producing a plasma display panel. In particular, the present invention relates to a method for producing a protective layer of a plasma display panel.

### BACKGROUND OF THE INVENTION

A plasma display panel (hereinafter also referred to as “PDP”) is suitable for displaying a high-quality television image on a large screen. Thus, there has been an increasing need for various kinds of display devices using the plasma display panel.

The PDP (for example, 3-electrode surface discharge type PDP) comprises a front panel and a rear panel opposed to each other. The front panel and the rear panel are sealed along their peripheries by a sealing material. Between the front panel and the rear panel, there is formed a discharge space filled with a discharge gas (helium, neon or the like).

The front panel is disposed at the front such as it faces the viewer. The front panel is generally provided with a glass substrate, display electrodes (each of which comprises a scan electrode and a sustain electrode), a dielectric layer and a protective layer. Specifically, (i) on one of principal surfaces of the glass substrate, the display electrodes are formed in a form of stripes; (ii) the dielectric layer is formed on the principal surface of the glass substrate so as to cover the display electrodes; and (iii) the protective layer is formed on the dielectric layer so as to protect the dielectric layer.

The rear panel is generally provided with a glass substrate, address electrodes, a dielectric layer, partition walls and phosphor layers (i.e. red, green and blue fluorescent layers). Specifically, (i) on one of principal surfaces of the glass substrate, the address electrodes are formed in a form of stripes; (ii) the dielectric layer is formed on the principal surface of the glass substrate so as to cover the address electrodes; (iii) a plurality of partition walls are formed on the dielectric layer at equal intervals; and (iv) the phosphor layers are formed on the dielectric layer such that each of them is located between the adjacent partition walls.

In the PDP, the display electrode and the address electrode perpendicularly intersect with each other, and such intersection portion serves as a discharge cell. A plurality of discharge cells are arranged in the form of a matrix. Three discharge cells which have red, green and blue phosphor layers serve as picture elements for color display. In operation of the PDP, ultraviolet rays are generated in the discharge cell upon applying a voltage, and thereby the phosphor layers capable of emitting different visible lights are excited. As a result, the excited phosphor layers respectively emit lights in red, green and blue colors, which will lead to an achievement of a full-color display.

The protective layer of the PDP may have two-layered structure composed of a thin film layer and a crystal layer. This protective layer serves to not only protect the dielectric layer from an ion bombardment caused by the discharges but also assist a light emitting of the phosphor by a secondary electron emission. Specifically, the thin film layer has a wall charge retaining function whereas the crystal layer has an initial electron emitting function. Such protective layer is usually formed from a magnesium oxide (MgO) since it has a high resistance to a sputtering and a high coefficient of the secondary electrons emission.

Japanese Unexamined Patent Publication (Kokai) No. 2007-10330 discloses a method for performing a vapor deposition process so as to form a thin MgO layer and performing an air spray process with a spray gun so as to form a MgO crystal layer. In this method, an ink prepared by dispersing a MgO crystal powder into a solvent is sprayed onto the thin MgO layer in the air spray process. In particular, according to the first embodiment of this method, the spray ink is prepared by dispersing the MgO crystal powder with a particle diameter of 500 Å or more into a solvent mixture consisting of “alcohol having a low boiling point (e.g. 2-propanol)” and “solvent having a molecular weight predetermined in accordance to the valence of a hydroxyl group”. “Solvent having molecular weight predetermined in accordance to the valence of a hydroxyl group” is capable of decreasing the apparent specific gravity since the hydroxyl group and the Mgo crystal powder attract each other and a hydrophobic group having a large molecular weight exists on the surface of the MgO crystal powder, so that the MgO crystal powder can be dispersed satisfactorily in the ink. According to the second embodiment of this method, the spray ink is prepared by dispersing the MgO crystal powder with a particle diameter of 500 Å or more into a solvent consisting of “alcohol having a low boiling point (e.g. 2-propanol)” and “at least one of anionic surfactant and an anion polymer”.

The conventional spray process using the spray gun has such a problem that a surface coverage of the Mgo crystal powder has a significant variability due to a variation in the discharge rate, the discharged amount, the splashed direction and/or the scattered direction of the powder. In the MgO crystal powder, electrons are trapped for a long period of time due to the energy level corresponding to the wavelength of peak CL emission. When the electrons are released by an electric field into the electric discharge space as initial electrons that trigger the electric discharge, a delay of the electric discharge is suppressed and also a probability of the electric discharge is improved. Therefore, the significant variability in the surface coverage of the MgO crystal powder makes it difficult to suppress the delay of the discharge and improve the probability of the discharge in the discharge cells of the PDP.

The conventional spray process also has such a problem that an efficiency of the ink to be used may decrease since the ink is splashed or scattered onto the outside of the necessary area. With this regard, it is advantageous to use a slit coater process since it can apply the ink to the necessary area with a constant discharge rate and a uniform concentration. However, as shown in FIG. 11 and FIG. 12, when the MgO crystal layer is formed by the slit coater process, there may be formed a region 53 where there is no MgO crystal powder around a protrusion 51 of the thin MgO layer, or a region 53 where the coverage of the MgO crystal powder is lower than that of a surrounding region 52 (this phenomenon will hereinafter also referred to as “repellent phenomenon”). The repellent phenomenon causes a problem that a uniform coverage of the MgO crystal powder deteriorates and thus it becomes difficult to suppress the delay of the electric discharge and improve the probability of the electric discharge. The protrusion 51 of the thin MgO layer is accidentally or inevitably formed during the process of producing the PDP front panel due to (A) a protrusion of dielectric layer; (B) an extraneous MgO attributable to a splashed MgO during a vapor deposition for forming the thin MgO layer; and/or (C) an extraneous material entering from a surrounding environment during the thin MgO layer forming process.

Moreover, when the MgO crystal layer is formed by the slit coater process, it is imperative to calcine the ink at a temperature of 400° C. or higher because the conventional ink contains a polymer. This causes a problem that not only the electric discharge characteristic of MgO may be deteriorated but also the ink properties may not be stable since there is a large variability in the molecular weight distribution of the polymer among production lots thereof.

### SUMMARY OF THE INVENTION

Under the above circumstances, the present invention has been created. Thus, an object of the present invention is to provide a method capable of suppressing the repellent phenomenon in the slit coater process and forming a protective layer by the use of a material that does not contain a polymer.

In order to achieve the above object, the present invention provides a method for producing a front panel of a plasma display panel wherein an electrode, a dielectric layer and a protective layer are formed on a substrate of the front panel,

a formation of the protective layer comprising the steps of:

(i) forming a first protective layer by a sputtering process or a vapor deposition process on a dielectric layer that has been formed on a substrate;

(ii) applying a MgO material onto the first protective layer to form a MgO material layer; and

(iii) drying the MgO material layer so as to form a second protective layer therefrom,

wherein

the MgO material to be used for forming the second protective layer comprises a MgO powder, a solvent A and a solvent B;

a vapor pressure of the solvent A is higher than and equal to about 50 Pa at 20° C.;

a vapor pressure of the solvent B is lower than and equal to about 7 Pa at 20° C.; and

a proportion of the solvent B to all solvents contained in the MgO material is higher than and equal to about 3% by weight.

According to the present invention, there is provided a protective layer of two-layered structure composed of the first protective layer and the second protective layer. The first protective layer is preferably a thin MgO layer whereas the second protective layer is preferably a Mgo crystal layer. The method of the present invention is characterized in that the MgO material to be used for forming the second protective layer contains no polymer and that the MgO material serves to prevent the repellent phenomenon from occurring even when the MgO material is applied by the slit coater process, followed by a drying treatment thereof. In other words, the present invention is characterized in that the MgO material contains the MgO powder, the solvent A and the solvent B wherein a vapor pressure of the solvent A at 20° C. is about 50 Pa or higher, a vapor pressure of the solvent B at 20° C. is about 7 Pa or lower, and a proportion of the solvent B to all solvents contained in the MgO material is about 3% by weight or more.

As used in this specification, the term “thin MgO layer” substantially means a MgO layer with a thickness of about 0.1 to 2 μm formed by a sputtering process or a vapor deposition process. While on the other hand, the term “MgO crystal layer” as used in this specification substantially means a MgO layer with a thickness of about 0.1 to 5 μm formed by applying a material (preferably paste material) containing MgO crystal powder and then drying it. In the MgO crystal layer, the MgO powder substantially exists on the thin MgO layer, and thus the MgO crystal layer may also be referred to as “MgO powder layer”. In this regard, the thickness of the MgO crystal layer can substantially correspond to the particle size of the MgO powder.

In one preferred embodiment, a proportion of the solvent B to all solvents contained in the MgO material is lower than and equal to about 20% by weight. This can enhances the effect of suppressing the repellent phenomenon.

It is preferred that a viscosity of the MgO material is lower than and equal to about 7 mPa·s. This makes it possible to more satisfactorily apply the MgO material by the slit coater process and suppress an aggregation or agglomeration of the MgO powder during a drying treatment of the applied MgO material. It is preferred that the solvent B contained in the MgO material comprises a hydrophilic group. This makes it possible to improve a wettability of the solvent B to MgO, and thereby improving the dispersion characteristic of the MgO powder in the material.

In accordance with the method of the present invention, the repellent phenomenon of the MgO material is prevented upon forming the second protective layer. In other words, the MgO crystal layer with a uniform surface coverage can be formed (namely, a uniform distribution of the MgO crystal layer is achieved), and thereby the delay of the electric discharge is suppressed and also the probability of the electric discharge is improved and uniformed. As a result, the obtained plasma display panel can have a satisfactory electric discharge characteristic free from a selection failure.

In accordance with the method of the present invention, the MgO material with no polymer is used, and thus it is not necessary to heat the MgO material at a high temperature (for example, about 400° C. or higher as described in “BACKGROUND OF THE INVENTION”) upon forming the protective layer. This makes it possible to prevent a deterioration of the electric discharge characteristic of the protective layer.

### BRIEF DESCRIPTION OF THE DRAWINGS

FIG. 1 is a perspective view schematically showing a structure of PDP.

FIG. 2 is a schematic sectional view of a front panel of PDP produced by a method of the present invention.

FIG. 3 is a diagram schematically showing the repellent diameter and the diameter of an extraneous material in Example.

FIG. 4 is a graph showing the results of Confirmatory test 1 for solvent component effect of ink.

FIG. 5 is a diagram schematically showing a pitch of ribs (partition walls) in rear panel.

FIG. 6 is a graph showing the results of Confirmatory test 2 for solvent component effect of ink.

FIG. 7 is a diagram schematically showing a mechanism of a repellent phenomenon.

FIG. 8 is a graph showing a relationship between the viscosity of MgO material and the required wet film thickness thereof.

FIG. 9 is a diagram schematically showing the CAP margin of a slit coater.

FIG. 10 is an electron microscope photograph of aggregated or agglomerated MgO powder.

FIG. 11 is a perspective view schematically showing a form of the repellent phenomenon.

FIG. 12 is an electron microscope photograph of a protective layer wherein a repellent phenomenon has occurred.

### DESCRIPTION OF REFERENCE NUMERALS

1 . . . Front panel
2 . . . Rear panel (or Back panel)
10 . . . Substrate of front panel
11 . . . Electrode of front panel (Display electrode)
12 . . . Scan electrode
12a . . . Transparent electrode
12b . . . Bus electrode
13 . . . Sustain electrode
13a . . . Transparent electrode
13b . . . Bus electrode
14 . . . Black stripe (Light shielding layer)
15 . . . Dielectric layer of front panel
16a . . . First protective layer (thin MgO layer)
16b . . . Second protective layer (MgO crystal layer or MgO powder layer)
20 . . . Substrate of rear panel
21 . . . Electrode of rear panel (Address electrode)
22 . . . Dielectric layer of rear panel
23 . . . Partition wall (Barrier rib)
25 . . . Phosphor layer (Fluorescent layer)
30 . . . Discharge space
32 . . . Discharge cell
51 . . . Protrusion of thin MgO layer
52 . . . Region where there is MgO powder with predetermined coverage
53 . . . Region where there is no MgO powder or MgO coverage is lower than that of the surrounding region 52
70 . . . Nozzle of slit coater
100 . . . PDP

### DETAILED DESCRIPTION OF THE PREFERRED EMBODIMENT

Hereinafter, a method for producing a plasma display panel according to the present invention will be described in detail.

### [Construction of Plasma Display Panel]

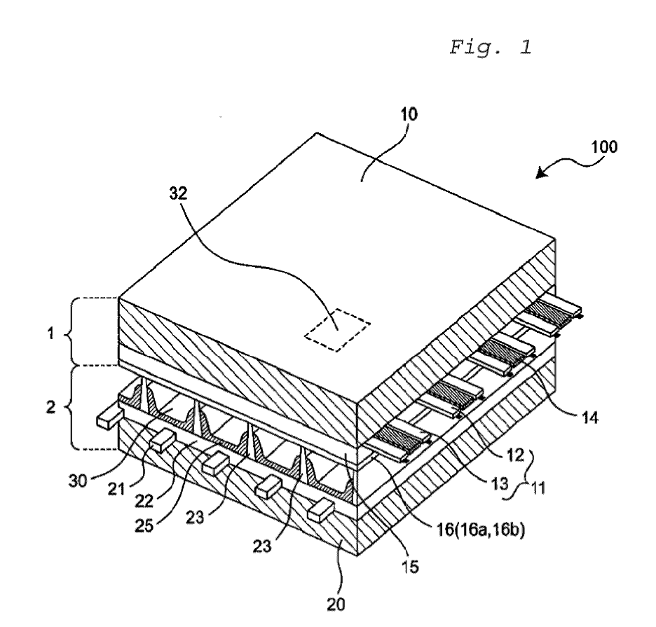

First, a plasma display panel (PDP) which can be finally obtained by a method of the present invention is described below. FIG. 1 schematically shows a perspective and sectional view of the construction of PDP.

In a front panel (1) of PDP (100), a plurality of display electrodes (11) composed of a scan electrode (12) and a sustain electrode (13) are formed on a substrate (10). As the substrate (10), a smooth, transparent and insulating substrate (e.g. glass substrate) may be used. A dielectric layer (15) is formed over the substrate (10) so as to cover the display electrodes (11). A protective layer (16) is formed on the dielectric layer (15). Each of the scan electrode (12) and the sustain electrode (13) is composed of a transparent electrode and a bus electrode (made of Ag, for example) wherein the transparent electrode and the bus electrode are electrically interconnected. Optionally, there may be provided a light-shielding layer (14) on the substrate (10).

In a rear panel (2) arranged opposed to the front panel (1), a plurality of address electrodes (21) are formed on an insulating substrate (20). A dielectric layer (22) is formed over the substrate (20) so as to cover the address electrodes (21). A plurality of partition walls (23) are disposed on the dielectric layer (22) such that each walls (21) is located between the address electrodes (21). Phosphor layers (25) such as red, green and blue fluorescent layers are formed on a surface of the dielectric layer (22) such that each fluorescent layer is located between adjacent partition walls (23).

The front panel (1) and the rear panel (2) are opposed to each other while interposing the partition walls (23) such that the display electrode (11) and the address electrode (21) perpendicularly intersect with each other. Between the front panel and the rear panel, there is formed a discharged space filled with a discharge gas. As the discharged gas, a noble gas (e.g. helium, neon, argon or xenon) is used. With such a construction of the PDP (100), the discharge space (30) is divided by the partition walls (23). Each of the divided discharge space (30), at which the display electrode (11) and the address electrode (21) intersect with each other, serves as a discharge cell (32).

### [General Method for Production of PDP]

Next, a typical production of the PDP (100) will be briefly described. The typical production of the PDP (100) comprises a step for forming the front panel (1) and a step for forming the rear panel (2).

As for the step for forming the front panel (1), the display electrode (11) is firstly formed on the glass substrate (10). Specifically, a transparent electrode is formed on the glass substrate (10) by a sputtering process, and subsequently a bus electrode is formed on the transparent electrode by a calcining process. Next, a dielectric material is applied over the glass substrate (10) so as to cover the display electrode (11), followed by a heat treatment thereof to form the dielectric layer (15). Next, the protective layer (16) is formed on the dielectric layer (15). Namely, a film made of MgO is provided by the process described above or a process to be described below.

As for the step for forming the rear panel (2), the address electrode (21) is firstly formed on the glass substrate (20) by a calcining process. Next, a dielectric material is applied over the glass substrate (20) so as to cover the address electrode (20), followed by a heat treatment thereof to form the dielectric layer (22). Subsequently, the partition walls (23) made of a low-melting point glass are formed in a form of predetermined pattern. Then a phosphor material is applied between the adjacent partition walls (23) and then calcined to form the phosphor layer (25). Next, a low-melting point frit glass material is applied onto a periphery of the substrate (20) and then calcined to form a sealing component (not shown in FIG. 1).

After the front and rear panels are obtained, a so-called panel sealing step is performed. Specifically, the front panel (1) and rear panel (2) are disposed opposed to each other and then heated in their fixed state to soften the sealing component therebetween. Such sealing step enables the front panel and the rear panel to be air-tight bonded with each other by the sealing component. After the sealing step, the discharge space (30) is vacuumed while heating thereof, followed by a filling of the discharge space (30) with the discharge gas. In this way, PDP (100) is finally obtained.

### [Method of the Present Invention]

The method of the present invention relates to a production of the front panel, particularly to a formation of the protective layer of the front panel in the PDP production.

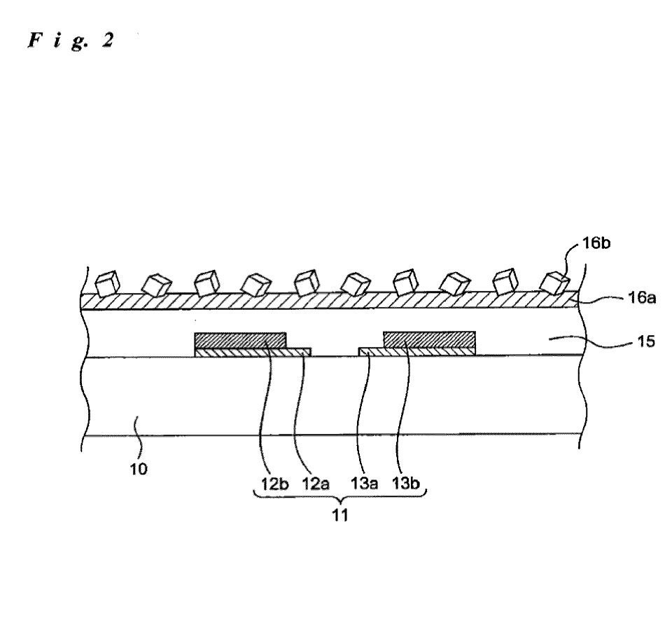

Referring to FIGS. 1 and 2, an embodiment of the present invention will be described. Upon carrying out the present invention, a substrate with an electrode and a dielectric layer formed thereon is prepared. Specifically, a glass substrate having display electrodes and the dielectric layer formed thereon is prepared.

Accordingly, there is firstly prepared a glass substrate (10) on which a display electrode (11) composed of a scan electrode (12) and a sustain electrode (13) is formed. Specifically, the substrate (10) itself is preferably an insulating substrate made of soda-lime glass, high-strain point glass or various kinds of ceramics. It is preferred that the thickness of the substrate (10) is in the range of from about 1.0 mm to 3 mm. As each of the scan electrode (12) and the sustain electrode, a transparent electrode made of ITO (about 50 nm to 500 nm in thickness) (12a, 13a) is provided, and also a bus electrode made of silver (about 1 μm to 8 μm in thickness) (12b, 13b) is provided on the transparent electrode to decrease the resistance value of the display electrode (see FIG. 2). More specifically, the transparent electrode is formed by a thin film process, and subsequently the bus electrode is formed by a calcining process. Particularly upon the formation of the bus electrode, first, a conductive paste containing silver as a main component is supplied in a form of stripes by a screen printing process so as to form a bus electrode precursor. Alternatively, the bus electrode precursor may be formed in a form of stripes by patterning it using photolithography wherein a photosensitive paste which mainly contains silver is applied by a die coating process or a printing process, and then dried at 100° C. to 200° C., followed by exposure and developing thereof. Moreover, the bus electrode precursor may be formed by a dispensing process or an ink-jet process. The resulting bus electrode precursor is dried and then finally calcined at 400° C. to 600° C. to form the bus electrode therefrom. On the transparent electrode, there may be formed a metal electrode made of a metal such as Al, Cu, Cr or the like, or made from a lamination of Cr/Cu/Cr.

Subsequent to the formation of the display electrodes (11), the dielectric layer (15) is formed. The dielectric layer (15) can be formed by a calcining process or a sol-gel process that is commonly employed in the manufacture of PDP front panels. For example, a dielectric material paste is firstly prepared by mixing a glass powder (e.g. glass powder with SiO₂, B₂O₃, ZnO and Bi₂O₃), an organic solvent and a binder resin. Subsequently, the dielectric material paste is applied by a screen printing process, and then the applied paste is heated to form the dielectric layer. The thickness of the dielectric layer (15) is preferably in the range of from about 5 μm to about 30 μm, more preferably in the range of from about 10 μm to about 20 μm. Examples of the organic solvent include alcohols (e.g. isopropyl alcohol) and ketones (e.g. methyl isobutyl ketone). Examples of the binder resin include a cellulose-based resin and an acrylic resin.

Subsequent to the formation of the dielectric layer (15), the protective layer is formed. Namely, the step (i) of the method of the present invention is performed wherein the first protective layer is formed on the dielectric layer by a sputtering process or a vapor deposition process. It is preferable to form the first protective layer that comprises magnesium oxide (MgO). In other words, a thin MgO layer is formed as the first protective layer. The thickness of the first protective layer is preferably in the range of from about 0.1 μm to about 2 μm, more preferably in the range of from about 0.5 μm to about 1 μm. As the vapor deposition process, CVD or PVD may be employed. The process is not limited to the sputtering process or the vapor deposition process, and other processes may be optionally employed as long as the desired thin MgO layer can be formed.

Subsequent to the formation of the first protective layer, the step (ii) of the method of the present invention is performed. In other words, the MgO material is applied onto the first protective (i.e. preferably the thin MgO layer) so as to form a MgO material layer. The MgO material contains a MgO powder, a solvent A and a solvent B. The MgO powder is preferably MgO crystal powder (fine MgO crystal powder), and more preferably MgO single crystal powder. The particle size of the MgO crystal powder or the MgO single crystal powder is preferably in the range of from about 0.2 μm to about 20 μm, more preferably in the range of from about 0.5 μm to about 10 μm. The proportion of the MgO powder contained in the MgO material is preferably in the rage of from 0.3 to 20% by weight, more preferably in the range of from 0.3 to 10% by weight, and still more preferably in the range of from 0.3 to 5% by weight, for example about 1% by weight (based on the weight of the Mgo material).

As described above, the Mgo material contains the solvent A and the solvent B. The solvent A and the solvent B should have somewhat different levels of vapor pressure for the reason of a convection that will occur in the MgO material during the drying step. Specifically, a vapor pressure of the solvent A at 20° C. is about 50 Pa or higher whereas a vapor pressure of the solvent B at 20° C. is about 7 Pa or lower. The vapor pressure of the solvent A at 20° C. is preferably in the range of from about 50 Pa to about 100 Pa, more preferably in the range of form about 50 Pa to about 75 Pa. The vapor pressure of the solvent B at 20° C. is preferably in the range of from about 2 Pa to about 7 Pa, more preferably in the range of from about 4 Pa to about 7 Pa.

The proportion of the solvent B to all solvents contained in the MgO material is about 3% by weight or more. Namely, the content of solvent B contained in the MgO material is about 3% by weight or more. As used in this specification and claims, the phrase “all solvents” substantially means the solvent A plus the solvent B in a case where the solvent of the Mgo material consists of the solvent A and the solvent B, and substantially means the solvent A plus the solvent B plus other solvent(s) in a case where the solvent of the MgO material additionally contains other solvent(s) (i.e. at least one kind of other solvent). The proportion of the solvent B to all the solvents contained in the MgO material is preferably in the range of from about 3% by weight to about 20% by weight, and more preferably in the range of from about 3% by weight to about 12% by weight. Examples of the solvent A include organic solvents such as 3-methoxy-3-methyl-1-butanol, n-heptyl alcohol, 2-ethoxy ethanol, 2-methoxy ethanol, n-hexyl alcohol and 2-methyl-1-propanol. The solvent B preferably comprises a hydrophilic group (for example, hydroxyl group, carboxyl group and/or amino group). Examples of the solvent B include organic solvents such as α-terpineol, propylene glycol, 2-octanol, dipropylene glycol, diethylene glycol monobutyl ether, tripropylene glycol methyl ether and glycerin.

It is preferred that a slit coater process is employed to apply the MgO material. The slit coater process is a process of applying a paste material to a desired surface by discharging a paste material under pressure from a wide nozzle. When the slit coater process is employed, a viscosity of the MgO material is preferably about 7 mPa·s or less in order to prevent an aggregation or agglomeration of the MgO powder from occurring. It should be noted that the MgO material is a non-Newtonian fluid in general, and thus “viscosity” used in this specification and claims substantially means a viscosity at shear rate of 100 s⁻¹ and temperature of 25° C. The viscosity of the MgO material is preferably in the range of from 3 mPa·s to 7 mPa·s, and more preferably in the range of from 4 mPa·s to 7 mPa·s.

The thickness of the MgO material layer formed by applying the MgO material (hereinafter also referred to as “wet film thickness”) is preferably in the range of from about 3 μm to about 20 μm. In a case where the slit coater process is employed, such wet film thickness is preferably in the range of from about 5 μm to about 13 μm, and more preferably in the range of from about 10 μm to about 13 μm for the reason of “applicator GAP margin”.

After the completion of forming of the MgO material layer, the step (iii) of the method of the present invention is performed. Specifically, the MgO material layer is dried to form the second protective layer from the MgO material layer. Namely, the MgO crystal layer is formed on the first protective layer. As used in this specification and claims, the term “drying” substantially means an embodiment wherein the solvents contained in the MgO material layer are allowed to evaporate so that they are removed from the MgO material layer. For example, the MgO material layer may be placed under a reduced pressure of 7 to 0.1 Pa or under a vacuum atmosphere. Alternatively, the MgO material layer may be subjected to a heat treatment at a temperature of about 100 to 400° C. under an atmospheric pressure. As required, “reduced pressure or vacuum atmosphere” and “heat treatment” may be combined with each other. After the drying treatment, the second protective layer may have a thickness less than a thickness of the MgO material layer due to a removal of the solvent. For example, the thickness of the second protective layer may be in the range of from about 0.1 μm to about 5 μm.

By performing the steps (i) to (iii) as described above, a front panel (1) of the PDP can be finally obtained wherein the protective layer has a two-layered structure composed of the first protective layer (i.e. preferably the thin MgO layer) and the second protective layer (i.e. preferably the Mgo crystal layer).

The rear panel (2) is produced as follows. First, a precursor layer for address electrode is formed by screen printing a silver (Ag)-containing paste onto a substrate (20) (i.e. glass substrate). Alternatively, the precursor layer is formed by performance of a photolithography process in which a metal film containing silver as a main component is formed over the entire surface of the substrate and is subjected to an exposure and development treatments. The resulting precursor layer is then calcined at a predetermined temperature (for example, about 400° C. to about 700° C.), and thereby the address electrodes (21) are formed. Then, a dielectric layer (22) (i.e. so-called “base dielectric layer”) is formed over the substrate (20) so as to cover the address electrodes (21). To this end, a dielectric material paste that mainly contains a glass component (e.g. a glass material made of SiO₂, B₂O₃, or the like) and a vehicle component is applied by a die coating process or the like, so that a dielectric paste layer is formed. The resulting dielectric paste layer is then calcined to form the dielectric layer (22) therefrom. Subsequently, the partition walls (23) are formed at a predetermined pitch. To this end, a material paste for partition wall is applied onto the dielectric layer (22) and then patterned in a predetermined form to obtain a partition wall material layer. The partition wall material layer is then heated to form the partition walls therefrom. Specifically, a material paste containing a low melting point glass material, a vehicle component, filler and the like as the main components is applied by a die-coating process or a screen printing process, and then the applied material paste is dried at a temperature of from about 100° C. to 200° C. The dried material is subsequently patterned in a predetermined form by performance of a photolithography process wherein an exposure and a development thereof are carried out. The resulting patterned material is subsequently is calcined at a temperature of from about 400° C. to 700° C., and thereby the partition walls are formed therefrom. Alternatively, the partition walls (23) can also be formed by drying a partition wall material film formed by a screen printing, patterning it with an exposure and development of a photosensitive resin-containing dry film, machining the wall material film with a sand blast, peeling off the dry film and finally calcining the wall material film. After the formation of the partition walls (23), the phosphor layer (25) is formed. To this end, a phosphor material paste is applied onto the dielectric layer (22) provided between the adjacent partition walls (23), and subsequently the applied phosphor material paste is calcined. Specifically, the phosphor layer (25) is formed by applying a material paste containing a fluorescent powder, a vehicle component and the like as the main components with a discharge nozzle or other means, followed by drying the applied paste at a temperature of about 100° C. For a red fluorescent powder, [YBO₃: Eu³⁺] may be used. For a green fluorescent powder, [Zn₂SiO₄: Mn] may be used. For a blue fluorescent powder, [BaMgAl₁₀O₁₇: Eu²⁺] may be used.

Through the steps described above, the rear panel (2) is completed wherein the address electrodes (21), the dielectric layer (22), the partition walls (23) and the phosphor layer (25) are formed on the substrate (20).

The front panel (1) and the rear panel (2) are disposed to oppose each other such that the display electrode (11) and the address electrode (21) perpendicularly intersect with each other. The front panel (1) and the rear panel (2) are then sealed with each other along their peripheries by the glass frit. The discharge space (30) formed between the front panel (1) and the rear panel (2) is evacuated and is then filled with a discharge gas (e.g. helium, neon and/or xenon) preferably under a pressure of 55 kPa to 80 kPa. This results in a completion of the PDP production.

The present invention has been hereinabove described with reference to preferred embodiments. It will be however understood by those skilled in the art that the present invention is not limited to such embodiments and can be modified in various ways. For example, the first protective layer and the second protective layer may have such a form that they cannot be clearly distinguished from each other. Namely, an interface or boundary between the first protective layer and the second protective layer may not be clearly formed.

### EXAMPLES

Tests were conducted to study the desirable composition and properties of the MgO material used for forming the second protective layer. In the following description of EXAMPLES, the MgO material is referred to as ink.

### <<Confirmatory Test 1 for Solvent Component Effect of Ink>>

The MgO ink containing the following components was used:
MgO crystal powder: MgO single crystal powder with a particle size of 0.5 to 10 μm
Solvent A: 3-methoxy-3-methyl-1-butanol
Solvent B: α-terpineol
   In order to study the effect of the difference in the solvent B content, four variations were prepared with respect to the solvent B content (i.e. proportion of the solvent B to all the solvents contained in the MgO ink). Specifically, four kinds of MgO inks with the solvent B content of 5% by weight (Run 1-1), 7.5% by weight (Run 1-2), 10% by weight (Run 1-3) and 0% by weight (Run 1-4) were prepared. The concentration of the MgO powder in the MgO ink was 1% by weight for Runs 1-1, 1-2, 1-3 and 1-4.

Upon preparing the MgO ink, 2000 g of the mixture constituted from the above components was subjected to an ultrasonic treatment for 30 minutes with amplitude of 20 μm so as to disperse the MgO crystal powder in the solvents, while preventing a lattice defect (e.g. chipping) from occurring in the surface of the MgO crystal powder.

The MgO ink thus prepared was applied onto a thin Mgo layer (with a thickness of about 0.7 μm) which had been formed by a vapor deposition process. Specifically, the MgO ink was applied by a slit coater process to form a MgO ink layer with a wet film thickness of 13 μm (by means of a slit coater apparatus manufactured by the applicant of the present invention). Subsequently, the MgO ink layer was dried in a vacuum atmosphere by reducing the pressure to 1 Pa, and thereby allowing the solvents to evaporate. As a result, a MgO crystal layer with thickness of about 1.0 μm was formed.

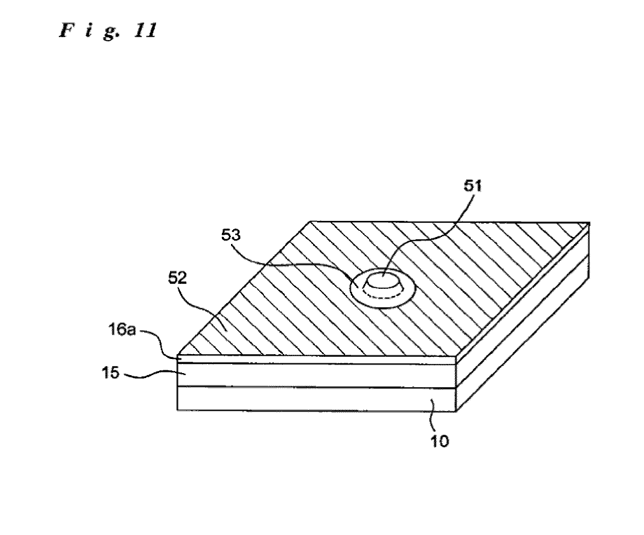

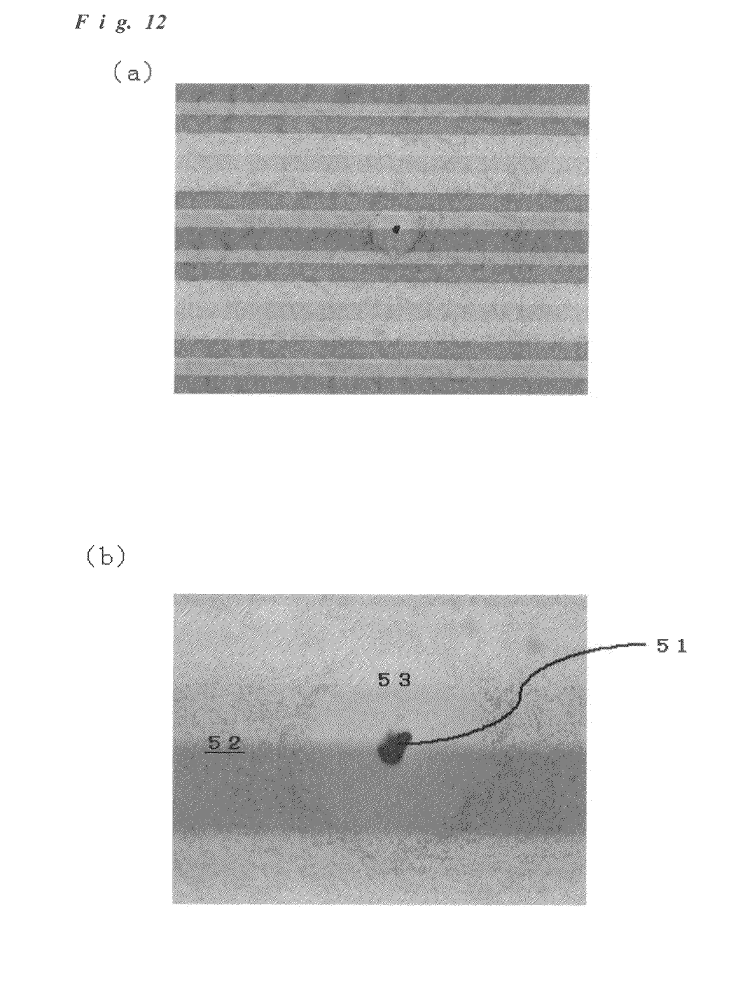

The thin MgO layer had the protrusion(s) 51 formed thereon due to (A) a protrusion of dielectric layer; (B) an extraneous MgO attributable to the splashed MgO during a vapor deposition for forming the thin MgO layer; and/or (C) an extraneous material entering from a surrounding environment during the thin MgO layer forming process. Accordingly, it should be noted that, when forming the MgO crystal layer by the slit coater process, a repellent phenomenon may take place in general. Namely, as shown in FIG. 11 and FIG. 12, there may be generally formed a region 53 where there is no MgO crystal powder around a protrusion 51 of the thin MgO layer, or a region 53 where the coverage of the MgO crystal powder is lower than that of a surrounding region 52.

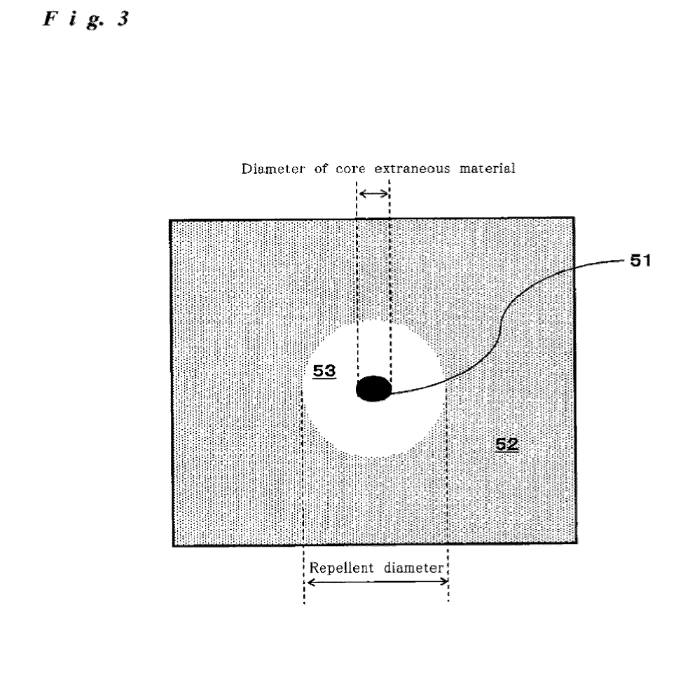

The repellent diameter shown in FIG. 3 was measured by means of an optical microscope with 50 times power of magnification. The repellent diameter in this test refers to the diameter of an equivalent circle having the area of the region 53 where there is no MgO crystal powder around the protrusion 51 (i.e. “core extraneous material”) of the thin MgO layer, or the region 53 where the coverage of the Mgo crystal powder is lower than that of a surrounding region 52 (in this case, the area of the region 53 includes the area of the core extraneous material).

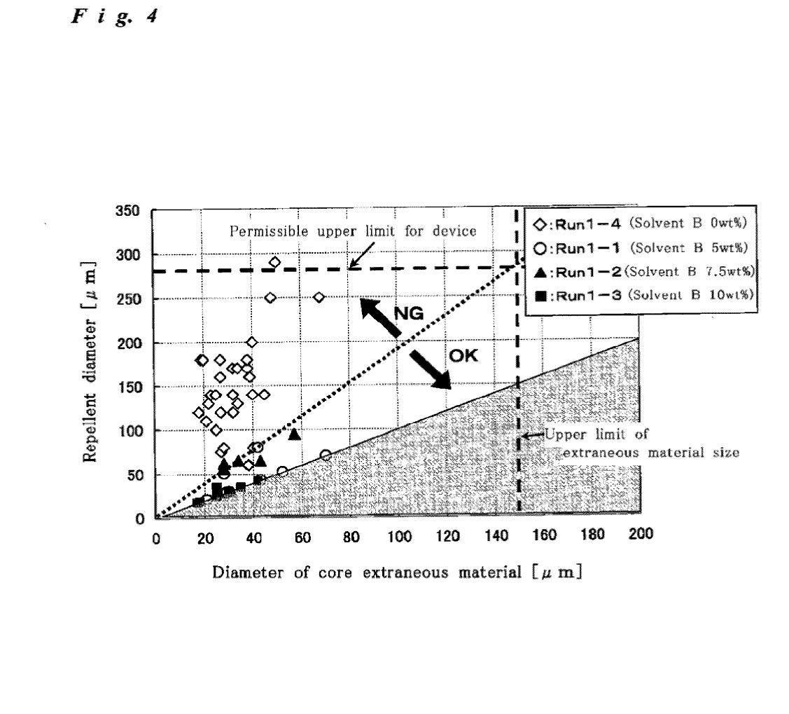

FIG. 4 shows a correlation between diameter of the core extraneous material and the repellent diameter regarding the MgO crystal layer.

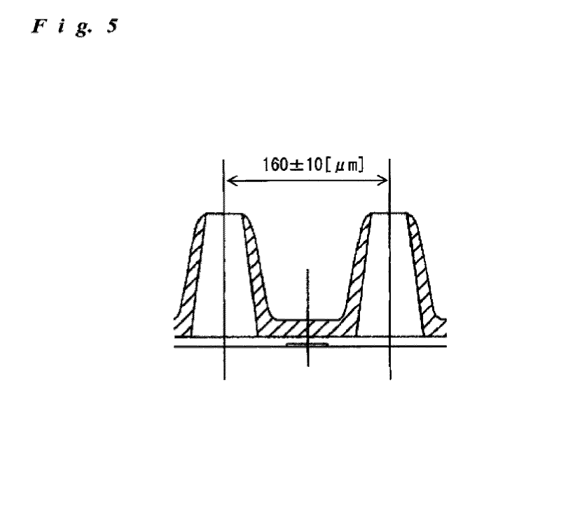

It is indispensable that a ratio of the repellent diameter to the diameter of the core extraneous material is not greater than 1.87 for the following reasons:
It is generally required that the upper limit of the diameter of the core extraneous material be 150 μm. This is because the ribs (partition walls) are disposed at a pitch of 160±10 μm in the PDP rear panel (see FIG. 5). In other words, the diameter of the core extraneous material larger than the minimum rib pitch (150 μm) leads to a higher probability of the extraneous material touching the rib to cause a chipping phenomenon of the rib when the front panel and the rear panel are opposed to form the PDP. This may result in a lighting failure of the PDP.
The permissible upper limit of the repellent diameter is 280 μm, considering a required function of the PDP. In particular, the lighting failure is prevented in a case of the PDP with the repellent diameter of 280 μm and lower. In general, the larger the diameter of the core extraneous material becomes, the larger the repellent diameter becomes.

As seen from the graph of FIG. 4, the ratio of the repellent diameter to the diameter of the core extraneous material was 1.83 (Run 1-1: content of the solvent B was 5% by weight), 1.67 (Run 1-2: content of the solvent B was 7.5% by weight) and 1.00 (Run 1-3: content of the solvent B was 10% by weight), all of which were satisfactory results since they are below the threshold of 1.87. This is supposedly because the solvent B having a proportion higher than a certain level to the solvent A results in a shorter migration of the MgO ink. Specifically, when the surface tension gradient of the solvents was generated by the film thickness gradient attributable to the surface irregularities, the resulting convective flows of the solvent A and the solvent B were caused to mix with each other so that a turbulence of the convective flows was promoted, and therefore the shorter migration of the MgO ink was provided.

While on the other hand, in the case of Run 1-4 (i.e. the proportion of the solvent B was 0% by weight), the ratio of the repellent diameter to the diameter of the core extraneous material was 4.50, which was higher than the threshold of 1.87. Namely, in the case where the proportion of the solvent B was 0% by weight, satisfactory result was not obtained. This is supposedly because there was occurred an orderly and uniform convection of the solvent A in the case of Run 1-4, due to that only a single solvent A was used. Specifically, when the surface tension gradient of the solvent is generated by the film thickness gradient attributable to the surface irregularities, the orderly and uniform convection of the solvent A causes it to move away from the extraneous material, and thereby the MgO crystal powder is also forced to move away from the core extraneous material toward the outside.

From the results described above, it was found that the ink must contains at least two kinds of solvents (i.e. solvent A and solvent B) and the content of one of the solvents (i.e. solvent B) must be 3% by weight or more.

### <<Confirmatory Test 2 for Solvent Component Effect of Ink>>

In order to study the effect of difference in vapor pressure of the solvent B, the MgO ink containing the following components was used:
MgO crystal powder: MgO single crystal powder with a particle size of 0.5 to 10 μm
Solvent A: 3-methoxy-3-methyl-1-butanol with vapor pressure of 67 Pa at 20° C.
Solvent B:
   Run 2-1: α-terpineol with vapor pressure of 5 Pa at 20° C.
   Run 2-2/2-3: Propylene glycol with vapor pressure of 11 Pa at 20° C.
   Run 2-4/2-5: 2-octanol with vapor pressure of 20 Pa at 20° C.
      Content of the solvent B in each Run is shown in Table 1.

TABLE 1

| | % by weight*¹ | Viscosity of ink (mPa · s)*² |
|---|---|---|
| Run 2-1 | 5 | 6.00 |
| Run 2-2 | 5 | 6.75 |
| Run 2-3 | 6 | 6.93 |
| Run 2-4 | 50 | 6.10 |
| Run 2-5 | 80 | 6.44 |

*¹Content (% by weight): proportion to all solvents (=the solvent A + the solvent B)
*²Viscosity at shear rate of 100 s⁻¹ and temperature 25° C.

Upon preparing the MgO ink, 2000 g of the mixture constituted from the above components was subjected to an ultrasonic treatment for 30 minutes with amplitude of 20 μm so as to disperse the MgO crystal powder in the solvents, while preventing a lattice defect (e.g. chipping) from occurring in the surface of the MgO crystal powder.

The MgO ink thus prepared was applied onto the thin MgO layer (with a thickness of about 0.7 μm) which had been formed by a vapor deposition process. Specifically, the MgO ink was applied by a slit coater process to form a MgO ink layer with a wet film thickness of 13 μm (by means of a slit coater apparatus manufactured by the applicant of the present invention). Subsequently, the MgO ink layer was dried in a vacuum atmosphere by reducing the pressure to 1 Pa, and thereby allowing the solvents to evaporate. As a result, a MgO crystal layer with thickness of about 1.0 μm was formed.

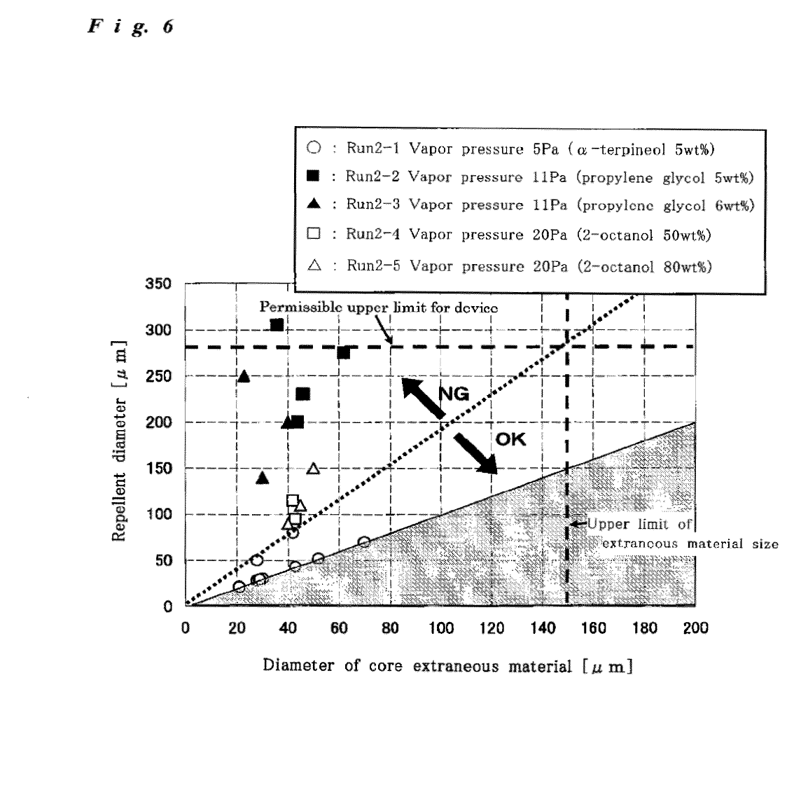

The correlation between diameter of the core extraneous material and the repellent diameter of the MgO crystal layer was evaluated in accordance to a criterion similar to that of “Confirmatory test 1 for solvent component effect of ink”. FIG. 6 is a graph showing a correlation between diameter of the core extraneous material and the repellent diameter regarding the MgO crystal layer.

As seen from the graph of FIG. 6, the ratio of the repellent diameter to the diameter of the core extraneous material was 1.83 for Run 2-1 wherein α-terpineol with vapor pressure of 5 Pa or less at 20° C. was used as the solvent B. The ratio of 1.83 was satisfactory results since it is below the threshold of 1.87. This is supposedly because there was a significant difference in the vapor pressure between the solvent A and the solvent B in the MgO ink. Specifically, when the surface tension gradient of the solvents was generated by the film thickness gradient attributable to the surface irregularities, the significant difference of the vapor pressures caused the convective flows of the solvent A and the solvent B to mix with each other so that a turbulence of convective flows was promoted, preventing the MgO crystal powder from moving away from the core extraneous material toward the outside.

While on the other hand, in the cases of Run 2-2˜2-5 wherein propylene glycol or 2-octanol with vapor pressure higher than 5 Pa at 20° C. was used as the solvent B, the ratio of the repellent diameter to the diameter of the core extraneous material was higher than the threshold of 1.87. Namely, in the case where the vapor pressure of the solvent B was higher than 5 Pa at 20° C., the satisfactory result was not obtained. This is supposedly because there was a little difference in the vapor pressures between the solvent A and the solvent B in the MgO ink. Specifically, when the surface tension gradient of the solvent was generated by the film thickness gradient attributable to the surface irregularities, the little difference of the vapor pressures caused two kinds of similar convections of the solvents A and B to be amplified with each other, and thereby the MgO crystal powder was forced to move away from the core extraneous material toward the outside.

From the results described above, it was found that a preferred vapor pressure of the solvent B (solvent with a hydrophilic group) should be equal to and lower than 7 Pa at 20° C.

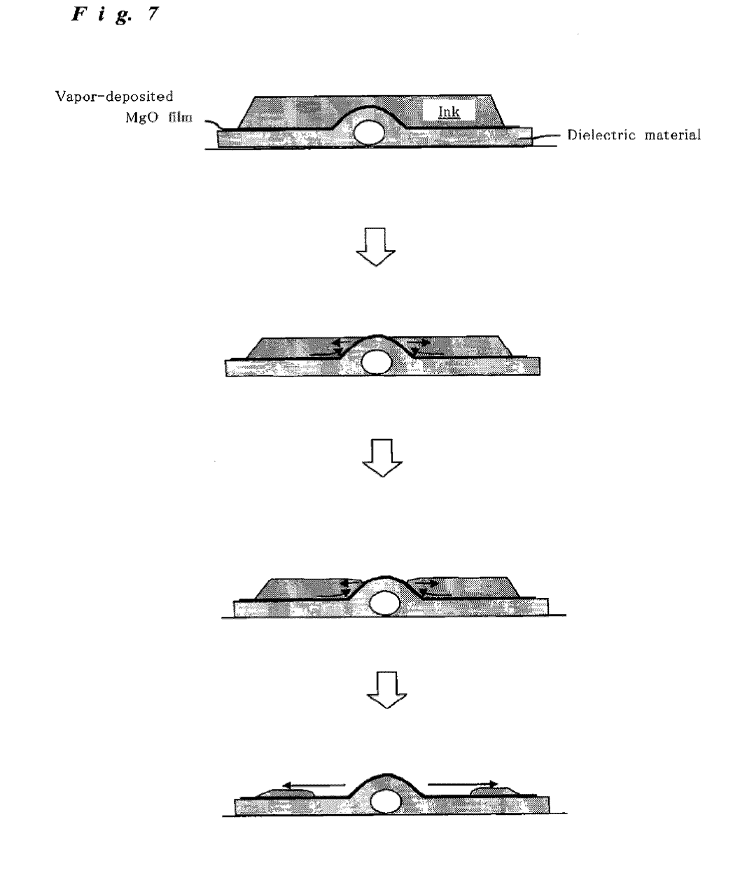

Just for reference, the mechanism of “repellent phenomenon” will be described here. During the process of drying the ink layer (i.e. MgO material layer), a concentration of a solid component contained in the ink tends to increase above the protrusion of the thin MgO layer (i.e. the protruded portion of the thin MgO layer being attributable to a dielectric layer protrusion, a MgO splash or an extraneous material from the surrounding environment), or the protrusion of the thin MgO layer emerges from the surface of the ink. This causes a disruption of the surface tension balance, and thereby the convection is generated so that the ink moves away from the protrusion (see FIG. 7). As a result, there is formed a region where no MgO crystal powder exists or small amount of MgO crystal powder exists around the protrusion of the thin MgO layer. With this regard, as verified in the confirmatory tests 1 and 2, the ink used in the present invention can suppress the convection of the solvent during the drying treatment. In other words, a mixture of the solvent A having a vapor pressure of 50 Pa or higher and the solvent B having a vapor pressure of 7 Pa or lower can suppress the convection of the solvent during the drying treatment of the MgO material layer. Moreover, the ink used in the present invention is in a paste form so that it has a relatively high viscosity. Thus, such viscous ink serves to suppress a MgO powder movement which may occur in connection with the convection of the solvent, thus constituting another factor that prevents the repellent phenomenon.

### <<Confirmatory Test for Viscosity Effect of Ink>>

The MgO ink containing the following components was used.
MgO crystal powder: MgO single crystal powder with a particle size of 0.5 to 10 μm
Solvent A: 3-methoxy-3-methyl-1-butanol
Solvent B: α-terpineol
   In order to study the effect of different levels of viscosity of the ink, the MgO inks with different viscosities were prepared. Specifically, the content of the solvent B was set to 0% by weight (Run 3-1), 7.5% by weight (Run 3-2), 10% by weight (Run 3-3) and 15% by weight (Run 3-4) to provide the different levels of viscosity of the MgO ink (see Table 2). The concentration of MgO powder was set to 1% by weight for Runs 3-1, 3-2, 3-3 and 3-4.

TABLE 2

| | Viscosity of ink (mPa · s)* |
|---|---|
| Run 3-1 | 6.0 |
| Run 3-2 | 6.7 |
| Run 3-3 | 7.0 |
| Run 3-4 | 8.0 |

*Viscosity at shear rate of 100 s⁻¹ and temperature of 25° C.

Upon preparing the MgO ink, 2000 g of the mixture constituted from the above components was subjected to an ultrasonic treatment for 30 minutes with amplitude of 20 μm so as to disperse the MgO crystal powder in the solvents, while preventing a lattice defect (e.g. chipping) from occurring in the surface of the MgO crystal powder.

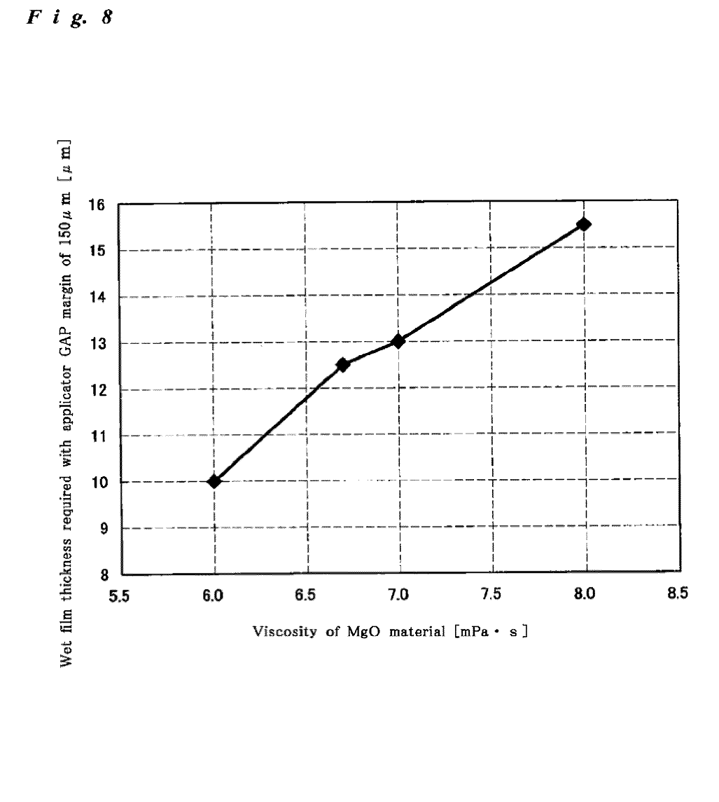

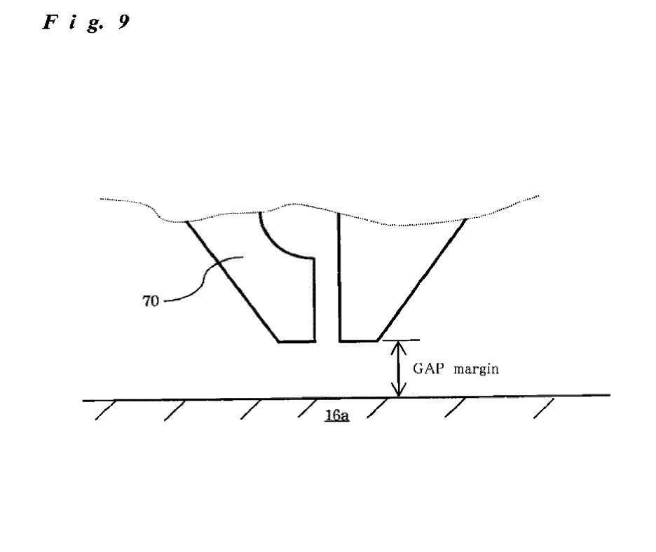

FIG. 8 shows a correlation between the viscosity of the MgO ink at a shear rate of 100 s⁻¹ (25° C.) and the wet film thickness required to apply the ink having this level of viscosity with GAP margin 150 μm of the slit coater (see FIG. 9). As seen from FIG. 8, the wet film thickness required to apply the ink with GAP margin of 150 μm tends to increase in proportion to the viscosity of the ink. In particular, the wet film thickness required for the viscosity 6.0 mPa·s of Run 3-1 is 10 μm, the wet film thickness required for the viscosity 6.7 mPa·s of Run 3-2 is 12.5 μm, the wet film thickness required for the viscosity 7.0 mPa·s of Run 3-3 is 13 μm, and the wet film thickness required for the viscosity 8.0 mPa·s of Run 3-4 is 15.5 μm.

The MgO ink thus prepared was applied onto the thin MgO layer such that the applied MgO ink had the required thickness. The thin MgO layer with a thickness of about 0.7 μm had been formed by vapor deposition. Specifically as for the application, the MgO ink was applied by performance of the slit coater process to form the wet film thickness of 10 μm (Run 3-1), 12.5 μm (Run 3-2), 13 μm (Run 3-3) and 15.5 μm (Run 3-4). Subsequently, the applied MgO ink was dried in a vacuum atmosphere by reducing the pressure to 1 Pa, and thereby the solvents are allowed to evaporate to form the MgO crystal layer with the thickness of about 1.0 μm for Run 3-1, about 1.1 μm for Run 3-2, about 1.0 μm for Run 3-3, and about 1.1 μm for Run 3-4. The MgO crystal layer thus formed was observed to study a distribution of the MgO crystal powder.

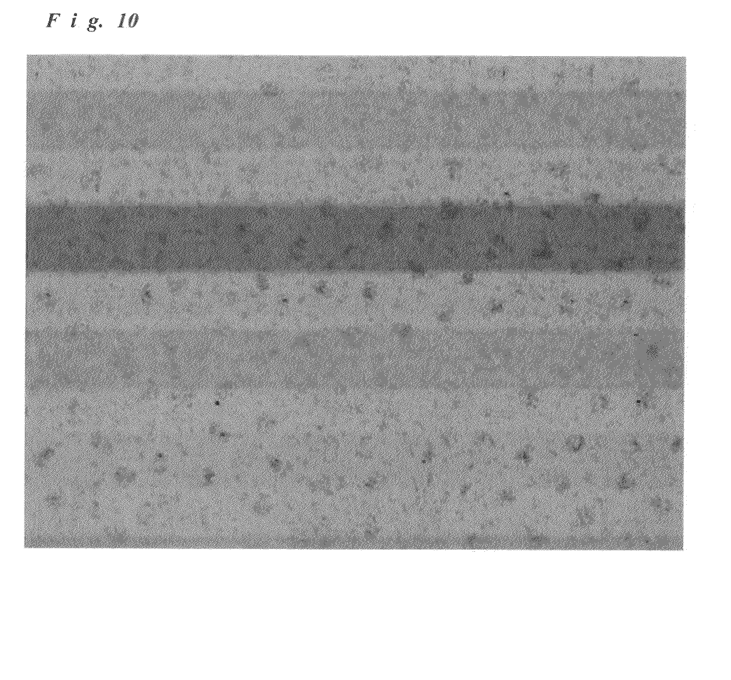

It was found that the MgO powder did not aggregate or agglomerate in the ink with a viscosity not higher than 7.0 mPa·s (i.e. Runs 3-1, 3-2, and 3-3). This is supposedly because the lower content of α-terpineol and the smaller wet film thickness made an evaporation time of the solvents shorter. Specifically, such shorter evaporation time forced the solvent to evaporate before the MgO powder aggregated or agglomerated, and thereby a significant movement of the MgO powder was suppressed. While on the other hand, it was found that the MgO powder aggregated or agglomerated in the ink with a viscosity higher than 7.0 mPa·s (i.e. Run 3-4). See FIG. 10. This is supposedly because the higher content of α-terpineol and the larger wet thickness made the evaporation time of the solvents longer, causing the MgO powder to aggregate or agglomerate with the significant movement thereof.

From the results described above, it was found that the ink viscosity of not higher than 7.0 mPa·s (at shear rate of 100 s⁻¹) makes it possible to produce a PDP with uniform brightness and satisfactory scanning characteristic, since the aggregation or agglomeration of the MgO powder is prevented.

### INDUSTRIAL APPLICABILITY

The PDP obtained by the method of the present invention has a satisfactory discharge characteristic, and thus it is not only suitable for household use and commercial use, but also suitable for use in other various kinds of display devices.

The method of the present invention is not limited to the PDP production and can be applied to other fields. For example, this method can be used in the field of battery and electronic components. Even in this field, an ink that does not contain a polymer/dispersant can be applied onto a substrate with surface irregularities so as to form a powder layer with an extremely uniform covering.

### CROSS REFERENCE TO RELATED PATENT APPLICATION

The disclosure of Japanese Patent Application No. 2008-146586 filed Jun. 4, 2008 including specification, drawings and claims is incorporated herein by reference in its entirety.

What is claimed is:

1. A method for producing a front panel of a plasma display panel wherein an electrode, a dielectric layer and a protective layer are formed on a substrate of the front panel,
a formation of the protective layer comprising:
(i) forming a first protective layer by a sputtering or vapor deposition process on a dielectric layer formed on a substrate;
(ii) applying a MgO material onto the first protective layer to form a MgO material layer; and
(iii) drying the MgO material layer so as to form a second protective layer therefrom,
wherein
the MgO material comprises a MgO powder, a solvent A and a solvent B;
a vapor pressure of the solvent A is higher than and equal to 50 Pa at 20° C.;
a vapor pressure of the solvent B is lower than and equal to 7 Pa at 20° C.; and
a proportion of the solvent B to all solvents contained in the MgO material is higher than and equal to 3% by weight.

2. The method according to claim 1, wherein a proportion of the solvent B to all solvents contained in the MgO material is lower than and equal to 20% by weight.

3. The method according to claim 1, wherein the solvent B comprises a hydrophilic group.

4. The method according to claim 1, wherein a viscosity of the MgO material is lower than and equal to 7 mPa·s; and
the MgO material is applied by a slit coater process.
